(19) United States
(12) Patent Application Publication
(10) Pub. No.: US 2024/0363830 A1
(43) Pub. Date: Oct. 31, 2024

(54) LITHIUM SECONDARY BATTERY

(71) Applicant: NGK INSULATORS, LTD., Nagoya-City (JP)

(72) Inventors: Kengo OISHI, Nagoya-City (JP); Ken SHIMAOKA, Nagoya-City (JP); Shigeki OKADA, Nagoya-City (JP)

(73) Assignee: NGK INSULATORS, LTD., Nagoya-City (JP)

(21) Appl. No.: 18/765,619

(22) Filed: Jul. 8, 2024

Related U.S. Application Data
(63) Continuation of application No. PCT/JP2023/002309, filed on Jan. 25, 2023.

(30) Foreign Application Priority Data
Jan. 27, 2022 (JP) 2022-011189

(51) Int. Cl. H01M 4/04; H01M 10/052; H01M 50/534

(52) U.S. Cl. CPC H01M 4/0471; H01M 10/052; H01M 50/534

(57) ABSTRACT

Provided is a lithium secondary battery including a sintered body, the sintered body including a laminate portion which includes a plurality of positive electrode layers, a plurality of negative electrode layers, and a separator, and in which the plurality of positive electrode layers and the plurality of negative electrode layers are alternately laminated through the separator. The sintered body includes a positive electrode connection portion connected to at least two or more of the plurality of positive electrode layers included in the laminate portion, the positive electrode connection portion containing 70 vol % or more and 100 vol % or less of a positive electrode active material for forming the plurality of positive electrode layers.

### TECHNICAL FIELD

The present disclosure relates to a lithium secondary battery. This application claims priority from Japanese Patent Application No. 2022-011189, filed on Jan. 27, 2022, the contents of which are incorporated herein by reference in their entirety.

### BACKGROUND ART

There has been known a lithium secondary battery including: a positive electrode layer including a sintered body of a lithium composite oxide; a negative electrode layer including a sintered body containing titanium; and a ceramic separator arranged between the positive electrode layer and the negative electrode layer. In Patent Literature 1, for example, there is a disclosure of a lithium secondary battery including an integrated sintered plate in which a positive electrode layer, a ceramic separator, and a negative electrode layer are bonded to each other, the battery being impregnated with an electrolytic solution. In Patent Literature 1, the lithium secondary battery includes, as the separator, a ceramic separator including MgO and glass.

In Patent Literature 2, there is a disclosure of an all-solid-state battery including a laminate in which a plurality of positive electrode layers and a plurality of negative electrode layers are alternately laminated through a solid electrolyte layer. The laminate as disclosed in Patent Literature 2 has a feature in that a buffer layer is provided in the solid electrolyte layer. The buffer layer may be provided in a solid electrolyte layer that is the outermost layer of the laminate, or may be provided in a solid electrolyte layer positioned in the middle of the laminate. Further, the buffer layer may be provided in a side margin layer arranged side by side with the positive electrode layer or the negative electrode layer so as to be provided at an outer periphery thereof. The buffer layer is formed of a combination of a metal portion and an air gap portion.

### CITATION LIST

### Patent Literature

[PTL 1] WO 2019/221144 A1
[PTL 2] JP 2021-27044 A

### SUMMARY OF INVENTION

### Technical Problem

It has been desired for the lithium secondary battery to have a low resistance and to be producible stably and efficiently.

In view of the foregoing, an object of the invention according to the present disclosure is to provide a lithium secondary battery having a low resistance and including an electrode that is producible stably and efficiently.

### Solution to Problem

According to an embodiment of the present disclosure, there is provided a lithium secondary battery including a sintered body, the sintered body including a laminate portion which includes a plurality of positive electrode layers, a plurality of negative electrode layers, and a separator, and in which the plurality of positive electrode layers and the plurality of negative electrode layers are alternately laminated through the separator. The sintered body includes a positive electrode connection portion connected to at least two or more of the plurality of positive electrode layers included in the laminate portion, the positive electrode connection portion containing 70 vol % or more and 100 vol % or less of a positive electrode active material for forming the plurality of positive electrode layers.

### Advantageous Effects of Invention

According to the lithium secondary battery described above, there is provided a lithium secondary battery including the sintered body that has a low resistance and has a good yield in production, thereby being producible stably and efficiently.

### BRIEF DESCRIPTION OF DRAWINGS

FIG. 1 is a schematic sectional view for illustrating a lithium secondary battery according to the present disclosure.

FIG. 2 is a schematic perspective view for illustrating a sintered body included in the lithium secondary battery according to the present disclosure.

FIG. 3 is a schematic sectional perspective view for illustrating a laminate portion of the sintered body included in the lithium secondary battery according to the present disclosure.

FIGS. 4A, 4B and 4C are schematic views for illustrating a part of a process of producing the sintered body included in the lithium secondary battery according to the present disclosure.

FIGS. 5A, 5B and 5C are schematic views for illustrating a part of a process of producing the sintered body included in the lithium secondary battery according to the present disclosure.

FIGS. 6A, 6B, 6C and 6D are schematic views for illustrating a part of a process of producing the sintered body included in the lithium secondary battery according to the present disclosure.

FIG. 7 is a schematic perspective view for illustrating an external appearance of the lithium secondary battery according to the present disclosure.

FIG. 8 is a schematic sectional view for illustrating a sintered body included in the lithium secondary battery according to the present disclosure.

FIG. 9 is a schematic view for illustrating a part of a process of producing the sintered body included in the lithium secondary battery according to the present disclosure.

FIG. 10 is a schematic view for illustrating a part of a process of producing the sintered body included in the lithium secondary battery according to the present disclosure.

### DESCRIPTION OF EMBODIMENTS

### Outline of Embodiments

First, embodiments of the present disclosure are listed and described. A lithium secondary battery according to the present disclosure includes a sintered body. The sintered body includes a laminate portion which includes a plurality of positive electrode layers, a plurality of negative electrode layers, and a separator, and in which the positive electrode layers and the negative electrode layers are alternately laminated through the separator. The sintered body includes a positive electrode connection portion connected to at least two or more of the positive electrode layers included in the laminate portion, the positive electrode connection portion containing 70 vol % or more and 100 vol % or less of a positive electrode active material for forming the positive electrode layers.

Hitherto, there has been known a lithium secondary battery including a laminate which includes a plurality of positive electrode layers and a plurality of negative electrode layers, and in which a plurality of cells are formed in one electrode (for example, Patent Literature 2). The all-solid-state battery as described in Patent Literature 2 includes the positive electrode layers, the negative electrode layers, and a solid electrolyte layer, and further includes a buffer layer including a metal portion and an air gap portion in the solid electrolyte layer. A first external terminal is attached to, out of side surfaces of the laminate as disclosed in Patent Literature 2, a side surface at which the positive electrode layers and positive electrode collector layers are exposed, and a second external terminal is attached to, out of the side surfaces, a side surface at which the negative electrode layers and negative electrode collector layers are exposed. As a specific mode of the external terminals, there is described a mode in which copper is baked on the side surface of the laminate and this surface is subjected to nickel plating or tin plating.

A laminate-type electrode including a plurality of positive electrode layers and a plurality of negative electrode layers has an advantage in that, although the electrode has a small size, a large capacity can be obtained. Meanwhile, when the laminate-type electrode is attempted to be formed of a sintered body, stability in production, that is, improvement of the yield becomes a challenge. Moreover, a lithium secondary battery having a lower resistance has been desired. The inventors of the present invention have conducted studies for reducing the resistance of the laminate-type electrode, and have paid attention to the configuration of the sintered body including the laminate. As a result, the inventors of the present invention have found that the laminate-type electrode achieving both of the low resistance and the stability in production can be obtained by providing, in the sintered body, a positive electrode connection portion connected to at least two or more of the positive electrode layers included in the laminate portion, and further setting a composition of this positive electrode connection portion to have a specific configuration.

The lithium secondary battery having the above-mentioned configuration can be stably produced because delamination is less liable to occur when the sintered body including the laminate is produced. Further, the lithium secondary battery having the above-mentioned configuration has a low resistance, and thus electricity can be efficiently taken out from the small-sized lithium secondary battery.

In the lithium secondary battery, the positive electrode connection portion may be a positive electrode side edge layer formed on, out of side surfaces of the sintered body, a first side surface that is a surface at which the positive electrode layers and the separator are exposed, the positive electrode side edge layer being in contact with end portions of the positive electrode layers included in the laminate portion. Focusing on the side surface of the laminate, according to a mode of forming the positive electrode side edge layer that is brought into contact with the end portions of the positive electrode layers exposed at the side surface of the laminate, the above-mentioned effect can be reliably obtained.

In the lithium secondary battery, the positive electrode connection portion may be a columnar portion extending so as to pass through the positive electrode layers and the separator in a laminating direction. In the sintered body including the columnar portion extending so as to pass through the positive electrode layers and the separator in the laminating direction, a coupling portion can be formed collectively for a large number of electrodes, and hence the productivity is more improved.

In the lithium secondary battery, the positive electrode side edge layer may be sintered integrally with the laminate portion. The phrase “sintered integrally” means that the laminate portion and the side edge layer are bonded to each other without interposing another bonding form (e.g., an adhesive or a bonding member) so as to be integrated as a sintered body (integrated sintered body). With this configuration, handleability as an electrode becomes excellent, and the electrode can be produced at rational cost.

In the lithium secondary battery, the positive electrode side edge layer may further contain a metal of at least one kind selected from the group consisting of Au (gold), Pt (platinum), and Ir (iridium). When the positive electrode side edge layer contains those metals, the effect of reducing the resistance can easily be obtained, and both of the low resistance and the stability in production can easily be achieved.

In the lithium secondary battery, a current collector may be provided on the outer side of the positive electrode side edge layer. With this configuration, a lithium secondary battery having the effects of the present disclosure can be formed without greatly changing the design of the related-art lithium secondary battery. Accordingly, a lithium secondary battery having a lower resistance and being excellent in stability in production can be achieved at rational cost.

In the lithium secondary battery, a negative electrode side edge layer may be formed on a second side surface that is a side surface opposed to the first side surface. The negative electrode side edge layer is formed of a metal of at least one kind selected from the group consisting of Au (gold), Pt (platinum), Ir (iridium), Pd (palladium), Ag (silver), Rh (rhodium), and Cu (copper), and is in contact with end portions of the negative electrode layers included in the laminate portion. With this configuration, the low-resistance positive electrode side edge layer is included on the positive electrode side, and further the negative electrode side edge layer made of a metal such as gold is provided on the negative electrode side. Thus, a lithium secondary battery having a lower resistance can be provided.

In the lithium secondary battery, each of the positive electrode layers may include a lithium composite oxide sintered body, and each of the negative electrode layers may include a titanium-containing sintered body. The positive electrode layer including the lithium composite oxide sintered body and the negative electrode layer including the titanium-containing sintered body are known configurations. A low-resistance lithium secondary battery can be obtained more stably by combining this known configuration with the above-mentioned configuration.

### Specific Examples of Embodiments

Next, a specific embodiment of the lithium secondary battery of the present disclosure is described with reference to the drawings. In the following drawings, the same or corresponding portions are given the same reference symbol, and hence their description is not repeated.

### (Lithium Secondary Battery)

First, the outline of the lithium secondary battery according to the present disclosure is described. FIG. 1 is a schematic sectional view for illustrating the structure of a lithium secondary battery 10 that is one embodiment according to the present disclosure. In FIG. 1, members of the same kind are represented by the same kind of hatching, and hence the representation of some reference symbols is omitted. The same holds true for any other figure. With reference to FIG. 1, an X-axis direction is referred to as “width direction of a laminate 1,” and a Z-axis direction is referred to as “laminating direction or thickness direction of the laminate 1.”

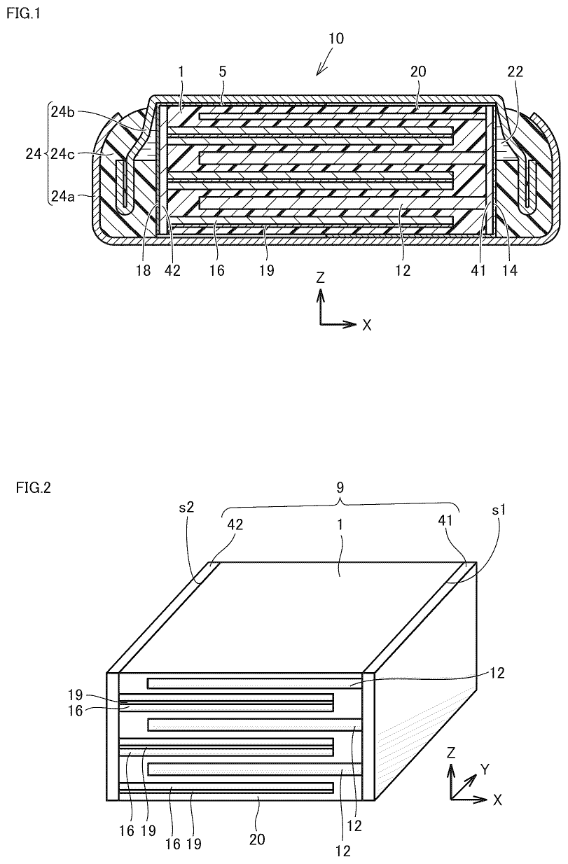

With reference to FIG. 1, the lithium secondary battery 10 has an electrode 5 accommodated inside of an exterior body 24. The electrode 5 includes the laminate 1 serving as a laminate portion in which a plurality of positive electrode layers 12, a plurality of negative electrode layers 16, and a separator 20 are laminated. A positive electrode side edge layer 41 serving as a positive electrode connection portion and a negative electrode side edge layer 42 serving as a negative electrode coupling portion are formed in contact with both side surfaces of the laminate 1, respectively. The laminate 1, the positive electrode side edge layer 41, and the negative electrode side edge layer 42 form a sintered body 9 (FIG. 2) serving as one integrated sintered body as a whole. That is, the laminate 1, the positive electrode side edge layer 41, and the negative electrode side edge layer 42 are bonded to each other. The term “integrated sintered body” as used herein means that the respective members for forming the sintered body are connected and bonded to each other without relying on any bonding approach (e.g., an adhesive) other than sintering. A positive electrode collector 14 and a negative electrode collector 18 are provided in contact with both side surfaces of the sintered body 9, respectively. The sintered body 9, the positive electrode collector 14, and the negative electrode collector 18 form the electrode 5.

In the laminate 1, the positive electrode layers 12 and the negative electrode layers 16 are alternately stacked on each other in the laminating direction. The separator 20 is interposed between the positive electrode layer 12 and the negative electrode layer 16. The positive electrode layer 12 and the negative electrode layer 16 are separated from each other by the separator 20. The positive electrode layer 12 is formed of, for example, a sintered body containing a lithium cobalt oxide. The negative electrode layer 16 is formed of, for example, a titanium-containing sintered body. The separator 20 is made of a ceramic.

The exterior body 24 has a closed space formed therein. The electrode 5 and an electrolytic solution 22 are stored in the closed space. The lithium secondary battery 10 has the electrolytic solution 22 sealed inside of the exterior body 24. The positive electrode layers 12, the negative electrode layers 16, and the separator 20 are also impregnated with the electrolytic solution 22.

The exterior body 24 only needs to be appropriately selected in accordance with the type of the lithium secondary battery 10. For example, when the lithium secondary battery 10 is in a coin battery form as illustrated in FIG. 1, the exterior body 24 typically includes a positive electrode can 24a, a negative electrode can 24b, and a gasket 24c. The positive electrode can 24a and the negative electrode can 24b are caulked through the gasket 24c to form the closed space. The positive electrode can 24a and the negative electrode can 24b may each be made of a metal such as stainless steel, and are not limited thereto. The gasket 24c may be a circular member made of an insulating resin, such as polypropylene, polytetrafluoroethylene, or a PFA resin, and is not particularly limited.

Although the lithium secondary battery 10 illustrated in FIG. 1 is in a coin battery form, the form of the lithium secondary battery according to the present disclosure is not limited to a coin battery. For example, other forms such as thin secondary batteries including a chip secondary battery and a pouch secondary battery are permitted. When the lithium secondary battery is a chip-type battery that can be built in a card, it is preferred that its exterior body be a resin substrate, and its battery elements (i.e., the electrode 5 and the electrolytic solution 22) be embedded in the resin substrate. When the lithium secondary battery is a pouch secondary battery, for example, the battery elements may be sandwiched between a pair of resin films. The pair of resin films may be bonded to each other with an adhesive. In addition, in the pair of resin films, the resin films may be thermally fused to each other by hot pressing. Further, the following configuration is permitted: a separator including a solid electrolyte is adopted as the separator, and the separator is free of an electrolytic solution.

With reference to FIG. 1, the electrode 5 of the lithium secondary battery 10 includes a positive electrode collector 14 extending from a side surface of the sintered body 9 to the lower surface thereof while being in contact with the sintered body 9. In addition, the lithium secondary battery 10 includes a negative electrode collector 18 extending from another side surface of the sintered body 9 to the upper surface thereof while being in contact with the sintered body 9. The positive electrode collector 14 and the negative electrode collector 18 may each be metal foil, such as copper foil or aluminum foil. The positive electrode collector 14 is preferably arranged between the positive electrode side edge layer 41 and the exterior body 24 (e.g., the positive electrode can 24a). The negative electrode collector 18 is preferably arranged between the negative electrode side edge layer 42 and the exterior body 24 (e.g., the negative electrode can 24b). In addition, a positive electrode-side carbon layer (not shown) is preferably arranged between the positive electrode side edge layer 41 and the positive electrode collector 14 from the viewpoint of reducing a contact resistance. Similarly, a negative electrode-side carbon layer (not shown) is preferably arranged between the negative electrode side edge layer 42 and the negative electrode collector 18 from the viewpoint of reducing a contact resistance. The positive electrode-side carbon layer and the negative electrode-side carbon layer each preferably include conductive carbon. The carbon layers may each be formed by, for example, applying a conductive carbon paste to the surface of metal foil to be used as a collector.

### (Sintered Body)

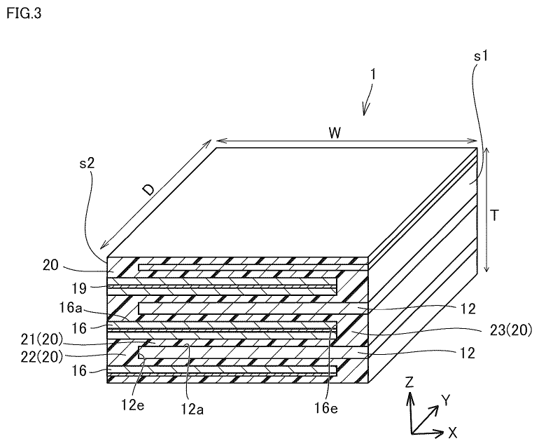

The sintered body included in the lithium secondary battery according to the present disclosure is described. FIG. 2 is a schematic perspective view for illustrating the sintered body 9 included in the lithium secondary battery according to the present disclosure. With reference to FIG. 2, the sintered body 9 includes the laminate 1 formed by stacking the plurality of positive electrode layers 12, the plurality of negative electrode layers 16, and the separator 20 in the Z-axis direction (thickness direction). The sintered body 9 further includes the positive electrode side edge layer 41 serving as the positive electrode connection portion and the negative electrode side edge layer 42 serving as the negative electrode coupling portion. The positive electrode side edge layer 41 and the negative electrode side edge layer 42 are formed on both side surfaces of the laminate 1, respectively. The positive electrode side edge layer 41 is formed in contact with a first side surface s1 of the laminate 1. The first side surface s1 is a surface at which the positive electrode layers 12 and the separator 20 are exposed (FIG. 3). The negative electrode side edge layer 42 is formed in contact with a second side surface s2 of the laminate 1. The second side surface s2 is a surface at which the negative electrode layers 16 and the separator 20 are exposed (FIG. 3). In the example illustrated in FIG. 2, the sintered body 9 has a rectangular parallelepiped shape (rectangular shape), but an outer shape of the sintered body is not limited thereto. For example, the outer shape of the sintered body may be a cylindrical shape (round shape) having side surfaces or other prism shapes.

### (Laminate Portion)

The laminate portion included in the lithium secondary battery according to the present disclosure is described. FIG. 3 is a schematic sectional perspective view for illustrating the laminate 1 serving as the laminate portion included in the lithium secondary battery according to the present disclosure. With reference to FIG. 3, the laminate 1 is a laminate in which many layers are laminated. The laminate 1 is a rectangular parallelepiped shape whose outer shape is defined by a width W, a depth D, and a thickness T. The term “rectangular parallelepiped” as used herein means not only a rectangular parallelepiped in a mathematically correct sense, but also includes a three-dimensional structure having a shape similar to the rectangular parallelepiped because of reasons in terms of design and production. In the laminate 1, a direction parallel to an X-axis illustrated in FIG. 3 is referred to as “width direction of the laminate,” a direction parallel to a Y-axis illustrated therein is referred to as “depth direction of the laminate,” and a direction parallel to a Z-axis illustrated therein is referred to as “laminating direction or thickness direction of the laminate.” In this description, surfaces of the laminate 1 at which all the laminated layers are exposed (surfaces illustrated as sections in FIG. 1) are referred to as “front surface” and “back surface.” The front surface and the back surface are surfaces parallel to an XZ plane. In addition, a surface of the laminate 1 at which its laminated structure is exposed, the surface extending between the front surface and the back surface and extending along the depth direction, is referred to as “side surface.” The side surface is a surface parallel to a YZ plane.

With reference to FIG. 3, the separator 20 is exposed at both of the uppermost surface and the lowermost surface of the laminate 1. In the laminate 1, the positive electrode layer 12 and the negative electrode layer 16 opposed to each other through the separator 20 form one cell. In the laminate 1 of FIG. 3, five cells are formed. Although the number of cells in the laminate included in the lithium secondary battery according to the present disclosure is not limited as long as the laminate has the effects of the invention, a laminate including, for example, three to two-hundred cells may be adopted.

In the laminate 1, the plurality of positive electrode layers 12 and the plurality of negative electrode layers 16 are alternately laminated. The positive electrode layers 12 and negative electrode layers 16 for forming the laminate 1 each have a quadrangular plate shape. The positive electrode layers 12 and the negative electrode layers 16 each have a width smaller than the width W of the laminate 1. Each of the negative electrode layers 16 includes a collector layer 19 on one of main surfaces thereof or inside thereof in the thickness direction. The positive electrode layers 12 and the negative electrode layers 16 are each exposed only at one side surface of the laminate 1. Specifically, all of the plurality of positive electrode layers 12 are exposed at the first side surface s1 of the laminate 1, but are not exposed at the second side surface s2. Each of the positive electrode layers 12 extends from the side surface s1 to the middle in the width direction of the laminate 1, and has an inner end surface 12e serving as a terminal in the width direction. Further, all of the plurality of negative electrode layers 16 are exposed at the second side surface s2 of the laminate 1, but are not exposed at the first side surface s1. Each of the negative electrode layers 16 extends from the side surface s2 to the middle in the width direction of the laminate 1, and has an inner end surface 16e serving as a terminal in the width direction.

The separator 20 is interposed between the positive electrode layer 12 and the negative electrode layer 16. The separator 20 includes a first region 21, a second region 22, and a third region 23. The first region 21 extends across the entire width W of the laminate 1, and is interposed between the positive electrode layer 12 and the negative electrode layer 16 in the thickness direction of the laminate 1. The second region 22 is arranged side by side with the positive electrode layer 12 in the X-axis direction, and extends between the side surface s2 and the inner end surface 12e of the positive electrode layer 12. The second region 22 functions as an insulating layer for insulating between the positive electrode layer 12 and the side surface s2. The third region 23 is arranged side by side with the negative electrode layer 16 in the X-axis direction, and extends between the side surface s1 and the inner end surface 16e of the negative electrode layer 16. The third region 23 functions as an insulating layer for insulating between the negative electrode layer 16 and the side surface s1. The first region 21, the second region 22, and the third region 23 are continuous in series without a boundary. The first region 21, the second region 22, and the third region 23 are regions divided for the sake of convenience of description, and the separator 20 is preferably an integrated structure that is continuous as a whole.

At the first side surface s1 of the laminate 1, the positive electrode layers 12 and the separator 20 are exposed, but no negative electrode layer 16 is exposed. Similarly, at the second side surface s2 of the laminate 1, the negative electrode layers 16 including the collector layers 19 and the separator 20 are exposed, but no positive electrode layer 12 is exposed. The positive electrode side edge layer 41 (FIG. 2) is provided in contact with the side surface s1. The positive electrode side edge layer 41 is a layer containing a large amount of positive electrode active material. Similarly, the negative electrode side edge layer 42 (FIG. 2) is provided in contact with the side surface s2. The negative electrode side edge layer 42 is a low-resistance metal layer. In the lithium secondary battery according to the present disclosure, the positive electrode side edge layer 41 and the negative electrode side edge layer 42 having specific configurations are provided so that a low resistance and a good producing yield are both achieved. Next, configurations of the respective layers are described.

### (Positive Electrode Layers)

The positive electrode layers 12 each include a sintered body containing a lithium cobalt oxide. The positive electrode layers 12 may each be free of a binder and a conductive aid. The lithium cobalt oxide is specifically, for example, LiCoO₂ (hereinafter sometimes abbreviated as “LCO”). For example, sintered bodies as disclosed in JP 5587052 B2 and WO 2017/146088 A1 may each be used as an LCO sintered body to be formed into a plate shape. The positive electrode layers 12 are each preferably the following oriented positive electrode layer: the positive electrode layer contains a plurality of primary particles each including a lithium cobalt oxide, and the plurality of primary particles are oriented at an average orientation angle of more than 0° and 30° or less with respect to the layer surface of the positive electrode layer. Examples of the structure, composition, and identification method of such oriented positive electrode layer include those disclosed in Patent Literature 1 (WO 2019/221144 A1).

Examples of the lithium cobalt oxide for forming the primary particles in each of the positive electrode layers 12 include, in addition to LCO, LiₓNiCoO₂ (lithium nickel cobalt oxide), LiₓCoNiMnO₂ (lithium cobalt nickel manganese oxide), and LiₓCoMnO₂ (lithium cobalt manganese oxide). In addition, the primary particles may each contain any other lithium composite oxide together with the lithium cobalt oxide. The lithium composite oxide is, for example, an oxide represented by LiₓMO₂ (where 0.05<x<1.10 is satisfied, M represents at least one kind of transition metal, and M typically contains one or more kinds of Co, Ni, and Mn).

When the positive electrode layer 12 includes a plate-like sintered body containing LCO, a transition metal element out of the elements for forming each of the positive electrode layers is Co. In addition, when the positive electrode layer 12 includes a sintered body containing LiₓNiCoO₂ (lithium nickel cobalt oxide), transition metal elements out of the elements for forming each of the positive electrode layers are Ni and Co. In addition, when the positive electrode layer 12 includes a sintered body containing LiₓCoNiMnO₂ (lithium cobalt nickel manganese oxide), transition metal elements out of the elements for forming each of the positive electrode layers are Ni, Co, and Mn. In addition, the same holds true for a positive electrode except for the lithium cobalt oxide-based positive electrode. For example, when the positive electrode includes LifePO₄ (lithium iron phosphate), the transition metal element out of the elements for forming each of the positive electrode layers is Fe. Further, the transition metal element for forming each of the positive electrode layers may be V (vanadium) or other transition metal elements.

The average particle diameter of the plurality of primary particles for forming each of the positive electrode layers 12 is preferably 5 μm or more. Specifically, the average particle diameter of the primary particles to be used in the calculation of the average orientation angle is preferably 5 μm or more, more preferably 7 μm or more, still more preferably 12 μm or more.

The positive electrode layers 12 may each include pores. When a sintered body includes pores, in particular, open pores, in the case where the sintered body is incorporated as a positive electrode layer into a battery, an electrolytic solution can be caused to permeate into the sintered body, and as a result, lithium ion conductivity can be improved. A porosity in each of the positive electrode layers 12 is preferably from 20% to 60%, more preferably from 25% to 55%, still more preferably from 30% to 50%, particularly preferably from 30% to 45%. The porosity of a sintered body may be measured in accordance with a known method.

The average pore diameter of each of the positive electrode layers 12 is preferably from 0.1 μm to 10.0 μm, more preferably from 0.2 μm to 5.0 μm, still more preferably from 0.25 μm to 3.0 μm. When the average pore diameter falls within the above-mentioned ranges, the occurrence of local stress concentration in a large pore is suppressed, and hence stress in the sintered body is uniformly released with ease. In addition, an improvement in lithium ion conductivity by the permeation of the electrolytic solution into the sintered body through its pores can be more effectively achieved.

Although the thickness of each of the positive electrode layers 12 in the laminate 1 is not particularly limited, the thickness is, for example, preferably from 2 μm to 200 μm, more preferably from 5 μm to 120 μm, still more preferably from 10 μm to 80 μm. When the thickness falls within such ranges, the electronic resistance of the layer is suppressed, and the transfer resistance of a Li ion in the electrolytic solution is also suppressed. Thus, there is an advantage in that the resistance of the battery can be reduced.

### (Separator)

The separator 20 includes a ceramic-made fine porous membrane. The separator 20 contains magnesia (MgO). Specifically, the separator may include, for example, magnesia (MgO) and glass. In the separator 20, MgO and the glass are present in particle forms bonded to each other by sintering. The ceramic in the separator 20 may contain, for example, Al₂O₃, ZrO₂, SiC, Si₃N₄, or AlN in addition to MgO and the glass.

The glass in the separator 20 contains preferably 25 wt % or more, more preferably 30 wt % to 95 wt %, still more preferably 40 wt % to 90 wt %, particularly preferably 50 wt % to 80 wt % of SiO₂. The content of the glass in the separator 20 is preferably from 3 wt % to 70 wt %, more preferably from 5 wt % to 50 wt %, still more preferably from 10 wt % to 40 wt %, particularly preferably from 15 wt % to 30 wt % with respect to the total weight of the separator 20. When the content falls within the ranges, both of a high yield and an excellent charge-discharge cycle characteristic can be effectively achieved. The addition of a glass component to the separator 20 is preferably performed by adding a glass frit to raw material powder for the separator. The glass frit preferably contains one or more of Al₂O₃, B₂O₃, and BaO as a component except SiO₂.

Although the thickness of the separator 20 in the laminate 1 is not particularly limited, for example, the thickness of the first region 21 (region between the positive electrode layer 12 and the negative electrode layer 16) of the separator 20 is preferably from 5 μm to 60 μm, more preferably from 10 μm to 30 μm. The thicknesses of the second region 22 and the third region 23 of the separator 20 may be equal to those of the positive electrode layer 12 and the negative electrode layer 16, respectively. Although the porosity of the separator 20 is also not particularly limited, the porosity may be set to, for example, from about 30% to about 70%, and is preferably from about 40% to about 60%.

### (Negative Electrode Layers)

The negative electrode layers 16 each include, for example, a plate-like sintered body containing a titanium-containing composition. The negative electrode layers 16 may each be free of a binder and a conductive aid. The titanium-containing sintered body preferably contains lithium titanium oxide Li₄Ti₅O₁₂ (hereinafter “LTO”) or a niobium-titanium composite oxide Nb₂TiO₇, and more preferably contains LTO. Although it has been known that LTO typically has a spinel structure, LTO may have any other structure at the time of the charge and discharge of the lithium secondary battery. For example, in LTO, a reaction advances at the time of the charge and the discharge under a state in which two phases, that is, Li₄Ti₅O₁₂ (spinel structure) and Li₇Ti₅O₁₂ (rock salt structure) coexist. Accordingly, the structure of LTO is not limited to the spinel structure. Part of LTO may be substituted with any other element. Examples of the other element include Nb, Ta, W, Al, and Mg. The LTO sintered body may be produced in accordance with, for example, a method as described in JP 2015-185337 A.

When the negative electrode layers 16 each include a sintered body containing LTO, the transition metal element out of the elements for forming each of the negative electrode layers is Ti. Further, when the negative electrode layers 16 each include a sintered body containing Nb₂TiO₇, the transition metal elements out of the elements for forming each of the negative electrode layers are Nb and Ti.

The negative electrode layers 16 each have a structure in which a plurality of primary particles are bonded to each other. Those primary particles each preferably include LTO or Nb₂TiO₇. The negative electrode layers 16 may be formed as an integrated sintered body together with the positive electrode layers 12 and the separator 20. In addition, the following may be performed: the negative electrode layers 16 are formed as a sintered body different from the integrated sintered body of the positive electrode layers 12 and the separator 20; and then, the sintered bodies are combined with each other.

Although the thickness of each of the negative electrode layers 16 in the laminate 1 is not particularly limited, the thickness is, for example, preferably from 1 μm to 150 μm, more preferably from 2 μm to 120 μm, still more preferably from 5 μm to 80 μm. A primary particle diameter that is the average particle diameter of the plurality of primary particles for forming each of the negative electrode layers 16 is preferably 1.2 μm or less, more preferably from 0.02 μm to 1.2 μm, still more preferably from 0.05 μm to 0.7 μm.

The negative electrode layers 16 each preferably include pores. When a sintered body includes pores, in particular, open pores, in the case where the sintered body is incorporated as a negative electrode layer into a battery, an electrolytic solution can be caused to permeate into the sintered body, and as a result, lithium ion conductivity can be improved. A porosity in each of the negative electrode layers 16 is preferably from 20% to 60%, more preferably from 30% to 55%, still more preferably from 35% to 50%. The average pore diameter of each of the negative electrode layers 16 is preferably from 0.08 μm to 5.0 μm, more preferably from 0.1 μm to 3.0 μm, still more preferably from 0.12 μm to 1.5 μm.

In the laminate 1, the negative electrode layers 16 may each include a collector layer 19. The collector layer 19 may be arranged inside each of the negative electrode layers 16 in its thickness direction, or may be formed so as to be exposed at one of the main surfaces of the negative electrode layer 16. The collector layer 19 may include a material excellent in conductivity. The collector layer 19 may include, for example, gold, silver, platinum, palladium, aluminum, copper, or nickel. The incorporation of the collector layer 19 can reduce the internal resistance of the laminate, in particular, that in its negative electrode.

### (Positive Electrode Side Edge Layer)

The positive electrode side edge layer 41 included in the lithium secondary battery 10 according to the present disclosure contains 70 vol % or more and 100 vol % or less of a positive electrode active material for forming the positive electrode layers 12. When the content percentage of the positive electrode active material in the positive electrode side edge layer is 70 vol % or more, the sintered body for forming the electrode can be produced stably while the resistance is reduced. Specifically, in the production of the sintered body for forming the electrode, the sintered body can be obtained with less occurrence of delamination and a good yield. Specific examples of the positive electrode active material include LiₓNiCoO₂ (lithium nickel cobalt oxide), LiₓCoNiMnO₂ (lithium cobalt nickel manganese oxide), and LiₓCoMnO₂ (lithium cobalt manganese oxide) in addition to LCO given as an example in the section of the description of the positive electrode layer 12.

As materials other than the positive electrode active material out of the materials for forming the positive electrode side edge layer 41, the positive electrode side edge layer 41 preferably contains a metal from the viewpoint of reducing the resistance. The metal that may be contained in the positive electrode side edge layer 41 is preferably, for example, at least one kind selected from the group consisting of Au (gold), Pt (platinum), and Ir (iridium). For example, the positive electrode side edge layer 41 preferably contains 30 vol % or less of Au. As the material for forming the positive electrode side edge layer 41, the content percentage of the positive electrode active material with respect to the total of the positive electrode active material and the metal is preferably 70% or more, more preferably 90% or more, still more preferably 95% or more. The positive electrode side edge layer 41 is more preferably formed of the positive electrode active material and the metal.

The positive electrode side edge layer 41 is provided in contact with at least a plurality of (two or more) end surfaces out of end surfaces of the positive electrode layers 12 exposed at the side surface s1 of the laminate 1. The positive electrode side edge layer 41 is a positive electrode connection portion connected to at least two or more of the positive electrode layers 12 included in the laminate 1. The positive electrode side edge layer 41 is preferably provided in contact with all of the end surfaces of the positive electrode layers 12 exposed at the side surface s1, and more preferably extends so as to cover the entire region of the side surface s1. It is considered that the resistance is reduced when the positive electrode side edge layer 41 is present between the positive electrode collector 14 (FIG. 1) and the positive electrode layers 12 so that the positive electrode side edge layer 41 connects the end surfaces of the positive electrode layers 12 to each other. Moreover, when the positive electrode side edge layer has a composition containing 70% or more of the positive electrode active material, peeling at a layer interface in the process of producing the electrode is prevented, and hence the production can be performed with a good yield. Further, when the positive electrode side edge layer 41 includes a sintered body, the side edge layer is not eluted even when a cycle of charge and discharge is repeated, and it is thus considered that a lithium secondary battery excellent in cycle resistance can be obtained.

The thickness of the positive electrode side edge layer 41 is not particularly limited, but is, for example, preferably from 2 μm to 500 μm, more preferably from 5 μm to 200 μm. In addition, the positive electrode side edge layer 41 may include a material that does not inhibit a reduction in resistance and is capable of suppressing interfacial peeling of the sintered body in addition to the above-mentioned materials. For example, the positive electrode side edge layer 41 may include a ceramic, such as an oxide, a silicate, a phosphate, a nitride, or a carbide, in addition to the positive electrode active material.

### (Negative Electrode Side Edge Layer)

The negative electrode side edge layer 42 included in the lithium secondary battery 10 according to the present disclosure is a layer interposed between the side surface s2 of the laminate 1 and the negative electrode collector 18. The negative electrode side edge layer 42 is provided in contact with at least a plurality of (two or more) end surfaces out of end surfaces of the negative electrode layers 16 exposed at the side surface s2 of the laminate 1. The negative electrode side edge layer 42 is a negative electrode coupling portion connected to at least two or more of the negative electrode layers 16 included in the laminate 1. The negative electrode side edge layer 42 is preferably provided in contact with all of the end surfaces of the negative electrode layers 16 exposed at the side surface s2, and more preferably extends so as to cover the entire region of the side surface s2. It is considered that the resistance is reduced when the negative electrode side edge layer 42 is present between the negative electrode collector 18 (FIG. 1) and the negative electrode layers 16 so that the negative electrode side edge layer 42 connects the end surfaces of the negative electrode layers 16 to each other. In particular, when the negative electrode side edge layer 42 is formed of a noble metal, such as Au, Pt, or Ir, the side edge layer is not eluted even when the cycle of charge and discharge is repeated, and it is thus considered that a lithium secondary battery excellent in cycle resistance can be obtained.

The metal for forming the negative electrode side edge layer 42 is preferably at least one kind or a combination of two or more kinds selected from the group consisting of Au (gold), Pt (platinum), Ir (iridium), palladium (Pd), Ag (silver), rhodium (Rh), and copper (Cu). When those metals are used, in the process of producing the sintered body 9 including the negative electrode side edge layer 42, the sintered body 9 can be stably obtained with less occurrence of delamination. Further, when the side surface s2 of the laminate 1 is covered through use of a metal material having a resistance lower than that of a conductive adhesive, electricity can be taken out from the negative electrode layers 16 more efficiently. In the lithium secondary battery according to the present disclosure, a current collector may be directly attached to the side surface s2 through the conductive adhesive without providing the negative electrode side edge layer 42.

### (Production Method)

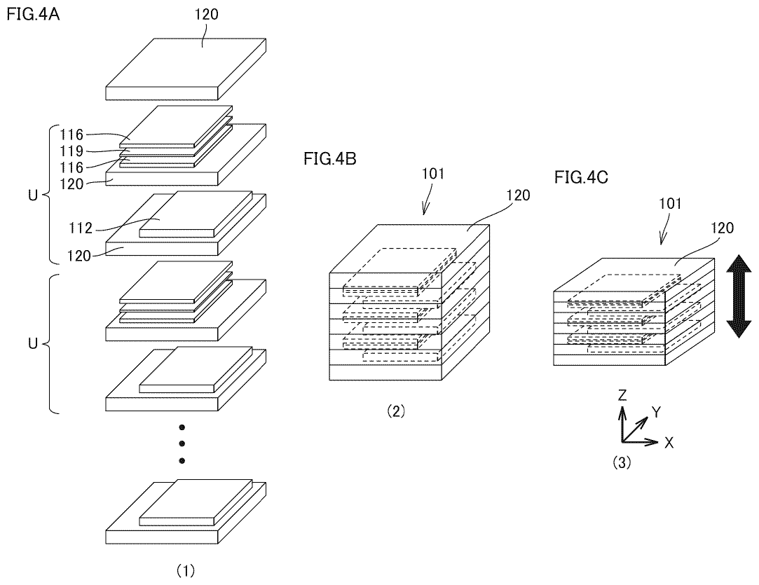

The outline of a method of producing the sintered body included in the lithium secondary battery according to the present disclosure is described. FIGS. 4A-4C schematically shows a step of preparing the sheets for forming the laminate and stacking and pressure-bonding the sheets in the process of producing the sintered body.

With reference to part (1) of FIG. 4A, a positive electrode green sheet 112, a negative electrode green sheet 116, and a separator green sheet 120 serving as materials for forming the laminate are each separately prepared. Typically, first, a slurry containing a raw material for forming each layer is prepared, and then, the prepared slurry is formed into a sheet shape on a resin film. Thus, a green sheet can be prepared. A collector layer 119 may be formed on one of the main surfaces of the negative electrode green sheet 116. With reference to part (2) of FIG. 4B, the respective sheets each cut into a predetermined width are sequentially stacked so that a predetermined layer configuration may be obtained. In the example of FIGS. 4a-4C, the layer configuration is simply illustrated, but a unit U including the negative electrode green sheet 116, the separator green sheet 120, the positive electrode green sheet 112, and the separator green sheet 120 may be repeatedly laminated to obtain a laminate having a larger number of layers.

With reference to part (1) of FIG. 4A, at the time of the stacking, each green sheet may be used alone in the thickness direction, or a form in which two or more sheets of the same kind are continuously superimposed in the thickness direction is also permitted. For example, in order to form the negative electrode layer 16, two negative electrode green sheets 116 each having the collector layer 119 on one surface may be superimposed. When two or more sheets of the same kind are superimposed in the thickness direction, the superimposed sheets are integrated in their sintering stage, and hence become one layer in a sintered body. When the two negative electrode green sheets 116 each having the collector layer 119 are superimposed, the sheets are preferably superimposed so that the collector layers 119 may be brought into contact with each other.

With reference to part (3) of FIG. 4C, a pressure is applied to a green sheet laminate 101 so that the layers are pressure-bonded to each other. Specifically, the green sheets included in the green sheet laminate 101 can be pressure-bonded to each other by pressing. The green sheet laminate 101 is preferably pressed in the thickness direction (Z-axis direction). The method of pressing may be, for example, cold isostatic pressing (CIP), warm isostatic pressing (WIP), or isostatic pressing, and the method is not particularly limited. The pressing may be performed while the green sheet laminate is heated.

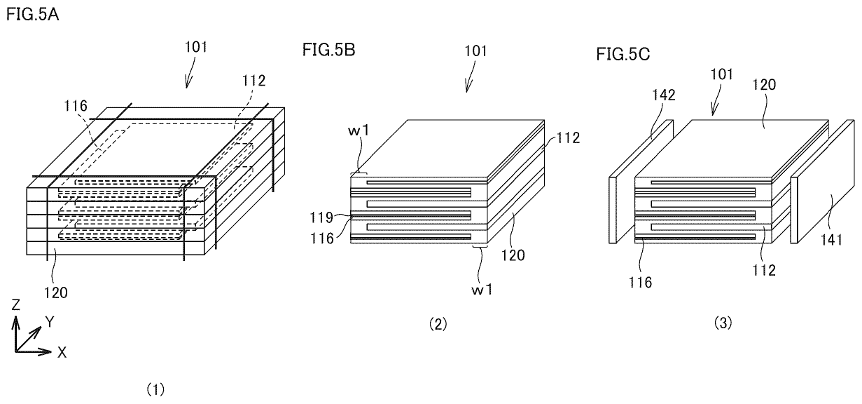

Subsequently, the green sheet laminate 101 is cut. FIG. 5 shows a part of the process in a case of producing a rectangular-shape sintered body, in which each layer is formed into a quadrangular shape, and which has a rectangular parallelepiped shape as a whole. Specifically, FIGS. 5A-5C schematically shows a step of cutting the green sheet laminate and arranging side edge portion green sheets on both side surfaces. With reference to part (1) of FIG. 5A, the green sheet laminate 101 is cut. In part (1) of FIG. 5A, a cutting site is indicated by the thick line. First, both side surfaces of the green sheet laminate 101 are cut so that the green sheet laminate 101 has a predetermined width. At this time, one of both the side surfaces is cut at a position at which the positive electrode layers are exposed but no negative electrode layer is exposed, and the other of both the side surfaces is cut at a position at which the negative electrode layers are exposed but no positive electrode layer is exposed. Subsequently, cutting is performed in a direction along the width direction (direction along the X-axis) so that a laminate having a predetermined depth can be obtained. A lamination form and a cutting site only need to be set in accordance with a desired sintered body form (dimensions as a whole, and the widths and thicknesses of the layers). As an example, cutting may be performed so that the laminate is 5 mm in each of the width direction (direction along the X-axis) and the depth direction (direction along the Y-axis). Further, as another example, cutting may performed so that a distance w1 from an inner terminal of the positive electrode layer or the negative electrode layer to the side surface becomes 0.5 mm. Part (2) of FIG. 5B shows the green sheet laminate 101 obtained after cutting.

Next, with reference to part (3) of FIG. 5C, a material for forming the side edge layer is arranged on each of both the side surfaces of the green sheet laminate 101. For example, a paste of the material for forming the side edge layer can be transferred onto the side surface of the green sheet laminate through use of pad printing or stamping printing. The material for forming the side edge layer can be prepared as a paste in advance. This paste is applied onto a base sheet such as a silicon film so that a base sheet for a side edge layer is produced. A paste application surface of the base sheet for the side edge layer is pressed against the side surface of the green sheet laminate so that the paste is transferred onto the side surface of the green sheet laminate. A positive electrode side edge material paste 141 is transferred onto the side surface of the green sheet laminate 101 on the side at which the positive electrode green sheets 112 are exposed. A negative electrode side edge material paste 142 is transferred onto the side surface thereof on the side at which the negative electrode green sheets 116 are exposed.

Next, degreasing and firing are performed to provide a laminate that is an integrated sintered body 9 (FIG. 2) including the side edge layer on each of both the side surfaces of the laminate. The degreasing and the firing may be performed under known conditions and by known methods. The thicknesses and widths of the respective layers in the resultant laminated integrated sintered body may be determined by, for example, polishing the laminated integrated sintered body with a cross section polisher, and observing the resultant section with a SEM.

Subsequently, collectors are attached to both the side surfaces of the sintered body. With reference to FIG. 1, the positive electrode collector 14 is attached to the positive electrode side edge layer 41 of the sintered body 9, and the negative electrode collector 18 is attached to the negative electrode side edge layer 42. A conductive material may be used as the positive electrode collector 14 or the negative electrode collector 18, and for example, aluminum foil or copper foil only needs to be used. The positive electrode collector 14 may be attached so as to cover the entirety of the positive electrode side edge layer 41, and may further be configured to extend to the lower surface of the sintered body 9. The negative electrode collector 18 may be attached so as to cover the entirety of the negative electrode side edge layer 42, and may further be configured to extend to the upper surface of the sintered body 9. The positive electrode side edge layer 41 and the positive electrode collector 14, or the negative electrode side edge layer 42 and the negative electrode collector 18 may be bonded to each other with a conductive adhesive. For example, a conductive carbon paste may be used as the conductive adhesive. The thickness of a conductive adhesive layer is not particularly limited as long as an effect as an adhesive layer is exhibited, and the effects of the invention are not inhibited. However, the thickness may be set to, for example, from about 1 μm to about 500 μm.

An electrode obtained by the above-mentioned production method is placed inside an exterior body in accordance with a known method and known conditions, and an electrolytic solution is sealed therein. Thus, the lithium secondary battery can be obtained.

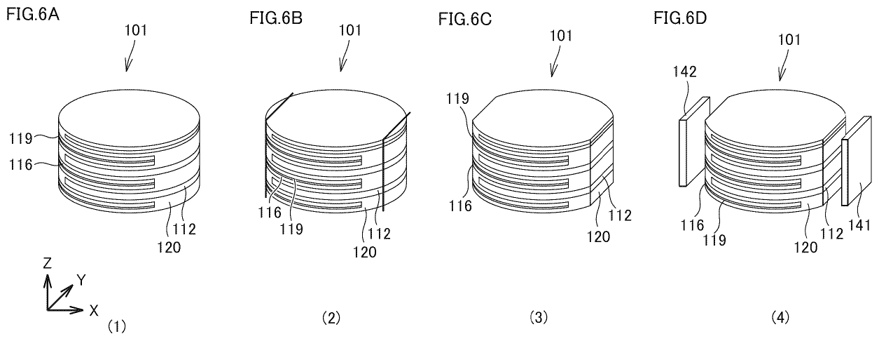

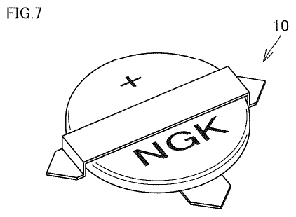

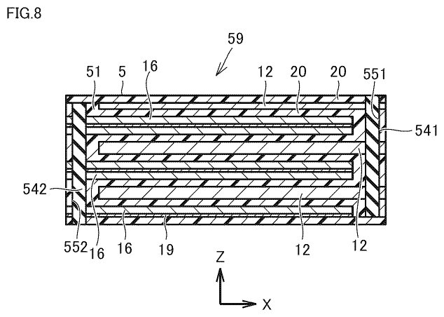

FIGS. 6A-6D shows an example of another embodiment of the sintered body included in the lithium secondary battery according to the present disclosure. FIGS. 6A-6D shows a part of a process in a case of producing a sintered body formed into a round shape to be a cylindrical body as a whole. As illustrated in FIGS. 6A-6D, the sintered body has a shape obtained by cutting parts of a column in parallel to a tangent line of a circle so that two opposed side surfaces are formed. This shape is referred to as “round shape.”

With reference to part (1) of FIG. 6A, the green sheet laminate 101 obtained in part (3) of FIG. 4C is cut out into a round shape through use of a puncher or the like so that the green sheet laminate 101 has a predetermined diameter. Next, with reference to part (2) of FIG. 6B, two portions of the cylindrical body are cut off at surfaces parallel to the depth direction of the green sheet laminate 101 (surfaces parallel to the YZ plane). With reference to part (3) of FIG. 6C, the positive electrode green sheets 112 are exposed at one of the two side surfaces appearing by the cut-off, and the negative electrode green sheets 116 are exposed at the other of the two side surfaces. The positive electrode side edge material paste 141 and the negative electrode side edge material paste 142 are arranged on those two side surfaces, respectively. The specific method can be similar to that in the case of the rectangular shape.

Next, similarly to the case of the rectangular shape, the degreasing and the firing are performed so that a round-shape sintered body is obtained. Subsequently, the current collector is arranged on each of the positive electrode side and the negative electrode side so that a round-shape electrode is obtained. Assembly is performed in a known procedure similarly to the case of the rectangular shape. Thus, for example, a lithium secondary battery having an external appearance illustrated in FIG. 7 can be obtained.

FIG. 8 to FIG. 10 show an example of another embodiment of the sintered body included in the lithium secondary battery according to the present disclosure. With reference to FIG. 8 and FIG. 10, a sintered body 59 has a cylindrical shape as a whole. The sintered body 59 includes a laminate 51, a positive electrode conducting portion 541 serving as a positive electrode connection portion, and a negative electrode conducting portion 542 serving as a negative electrode coupling portion. The positive electrode conducting portion 541 is a columnar portion extending in the laminating direction so as to fill a via 551 that is a bottomed hole extending in the laminating direction of the laminate 51. The negative electrode conducting portion 542 is a columnar portion extending in the laminating direction so as to fill a via 552 that is a bottomed hole extending in the laminating direction of the laminate 51. The configuration of the lamination in the laminate 51 is similar to that of the laminate 1. The same configuration is given the same reference symbol, and description thereof is omitted.

The positive electrode conducting portion 541 extends so as to pass through the plurality of positive electrode layers 12 and the separator 20 in the laminating direction. The positive electrode conducting portion 541 is preferably provided so as to be connected to all of the positive electrode layers 12 included in the laminate 51. Further, the positive electrode conducting portion 541 is arranged at a position not connected to the negative electrode layers 16. The negative electrode conducting portion 542 extends so as to pass through the plurality of negative electrode layers 16 and the separator 20 in the laminating direction. The negative electrode conducting portion 542 is preferably provided so as to be connected to all of the negative electrode layers 16 included in the laminate 51. Further, the negative electrode conducting portion 542 is arranged at a position not connected to the positive electrode layers 12.

The positive electrode conducting portion 541 may be formed of a material similar to that for the positive electrode side edge layer 41 described above. That is, the positive electrode conducting portion 541 contains 70 vol % or more and 100 vol % or less of the positive electrode active material for forming the positive electrode layers 12. Other materials are also similar to those for the positive electrode side edge layer 41, and description thereof is omitted.

The negative electrode conducting portion 542 may be formed of a material similar to that for the negative electrode side edge layer 42 described above. That is, a metal for forming the negative electrode conducting portion 542 is preferably at least one kind or a combination of two or more kinds selected from the group consisting of Au (gold), Pt (platinum), Ir (iridium), palladium (Pd), Ag (silver), rhodium (Rh), and Cu (copper).

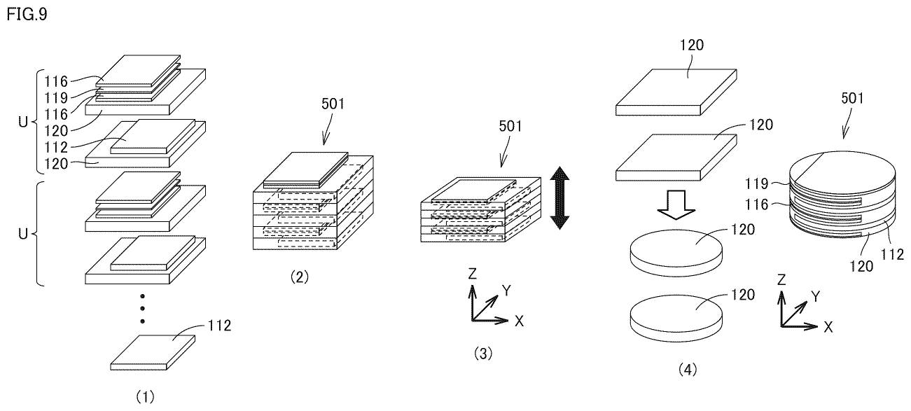

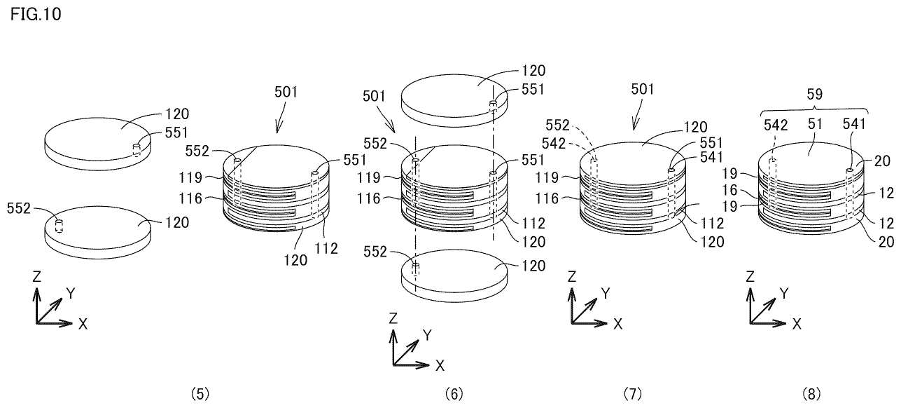

FIG. 9 and FIG. 10 are schematic views for illustrating a part of a process of producing the sintered body 59. With reference to FIG. 9 and FIG. 10, the process of producing the sintered body 59 is described. First, the positive electrode green sheet 112, the negative electrode green sheet 116, and the separator green sheet 120 serving as materials for forming the laminate are each separately prepared. Next, with reference to part (1) of FIG. 9, a plurality of positive electrode green sheets 112 and a plurality of negative electrode green sheets 116 are laminated so as to be alternately laminated through the separator green sheet 120. With reference to parts (2) and (3) of FIG. 9, after a green sheet laminate 501 is obtained, a pressure is applied to the green sheet laminate 501 so that the layers are pressure-bonded to each other. With reference to part (4) of FIG. 9, the green sheet laminate 501 obtained in part (3) of FIG. 9 is cut out into a round shape through use of a puncher or the like so that the green sheet laminate 501 has a predetermined diameter. Further, the separator green sheet 120 separately prepared is cut out into a round shape so that the separator green sheet 120 has a predetermined diameter.

With reference to part (5) of FIG. 10, the vias 551 and 552 are formed in the separator green sheet 120 and the green sheet laminate 501 obtained in part (4) of FIG. 9. The via 551 in the green sheet laminate 501 is provided at a position at which the via 551 passes through the positive electrode green sheets 112 without coming into contact with the negative electrode green sheets 116. The via 552 in the green sheet laminate 501 is provided at a position at which the via 552 passes through the negative electrode green sheets 116 without coming into contact with the positive electrode green sheets 112. Next, with reference to part (6) of FIG. 10, the separator green sheet 120 is laminated on each of the upper and lower surfaces of the green sheet laminate 501, and is pressure-bonded. At this time, the separator green sheet 120 is laminated so that the position of the via 551 in the separator green sheet 120 laminated on the upper surface of the green sheet laminate and the position of the via 551 in the green sheet laminate 501 match each other. Further, the separator green sheet 120 is laminated so that the position of the via 552 in the separator green sheet 120 laminated on the lower surface of the green sheet laminate and the position of the via 552 in the green sheet laminate 501 match each other. In the manner described above, the via 551 and the via 552 that are each a bottomed hole are formed. Next, with reference to part (7) of FIG. 10, the via 551 is filled with a material that becomes the positive electrode conducting portion 541. Further, the via 552 is filled with a material that becomes the negative electrode conducting portion 542. Next, degreasing and firing are performed. In the manner described above, with reference to part (8) of FIG. 10, the sintered body 59 in which the positive electrode conducting portion 541 and the negative electrode conducting portion 542 are formed in the laminate 51 is obtained.

### (Electrolytic Solution)

With reference to FIG. 1, the lithium secondary battery 10 may include the electrolytic solution 22. The electrolytic solution 22 is not particularly limited, and an electrolytic solution known as an electrolytic solution in a lithium secondary battery may be used. For example, one kind or a combination of two or more kinds selected from ethylene carbonate (EC), methyl ethyl carbonate (MEC), diethyl carbonate (DEC), ethyl methyl carbonate (EMC), propylene carbonate (PC), and γ-butyrolactone (GBL) may be used as a solvent. A lithium salt compound, such as lithium hexafluorophosphate (LiPF₆) or lithium tetrafluoroborate (LiBF₄), may be used as an electrolyte to be dissolved in the solvent. The electrolytic solution 22 may further contain at least one kind selected from vinylene carbonate (VC), fluoroethylene carbonate (FEC), vinylethylene carbonate (VEC), and lithium difluoro (oxalato) borate (LiDFOB) as an additive.

The concentration of the electrolyte in the electrolytic solution 22 is preferably from 0.5 mol/L to 2 mol/L, more preferably from 0.6 mol/L to 1.9 mol/L, still more preferably from 0.7 mol/L to 1.7 mol/L, particularly preferably from 0.8 mol/L to 1.5 mol/L.

In addition to the electrolytic solution 22, a solid electrolyte or a polymer electrolyte may be used as the electrolyte. In that case, as in the case of the electrolytic solution 22, at least the inside of each of the pores of the separator 20 is preferably impregnated with the electrolyte. Although a method for the impregnation is not particularly limited, examples thereof include: a method including melting the electrolyte to cause the electrolyte to infiltrate into the pores of the separator 20; and a method including pressing the compact of the electrolyte against the separator 20.

### Examples and Comparative Examples

The lithium secondary battery of the present disclosure is described in more detail below by way of Examples and Comparative Examples.

### Examples 1 to 4, and Comparative Examples 1 to 7

A lithium secondary battery was produced in accordance with a method described in the following sections 1 to 10. The resultant lithium secondary battery was evaluated by methods described in Evaluations 1 to 3.

### 1. Production of Laminate

The green sheets of respective layers for forming a laminate were produced under conditions described in the sections (1) to (3) and by methods described therein. In each of the sections (1) to (3), the viscosity of a slurry was measured with an LVT viscometer manufactured by Brookfield Engineering. At the time of the molding of the slurry on a PET film, a doctor blade method was used.

### (1) Production of LCO Green Sheet (Positive Electrode Green Sheet)

CO₃O₄ powder (manufactured by Seido Chemical Industry Co., Ltd.) and Li₂CO₃ powder (manufactured by the Honjo Chemical Corporation) weighed so that the molar ratio “Li/Co” became 1.01 were mixed, and then, the mixture was held at 780° C. for 5 hours. The resultant powder was pulverized in a pot mill so that a volume-based D₅₀ particle diameter became 0.4 μm. Thus, powder formed of LCO plate-like particles was obtained. 100 Parts by weight of the resultant LCO powder, 100 parts by weight of a dispersion medium (toluene:isopropanol=1:1), 8 parts by weight of a binder (polyvinyl butyral: product number: BM-2, manufactured by Sekisui Chemical Co., Ltd.), 2 parts by weight of a plasticizer (di(2-ethylhexyl) phthalate (DOP), manufactured by Kurogane Kasei Co., Ltd.), and 4.5 parts by weight of a dispersant (product name: RHEODOL SP-O30, manufactured by Kao Corporation) were mixed. The resultant mixture was stirred under reduced pressure to be defoamed, and its viscosity was adjusted to 4,000 cP. Thus, an LCO slurry was prepared. The prepared slurry was molded into a sheet shape on the PET film. Thus, an LCO green sheet was formed. The thickness of a positive electrode layer after its firing was adjusted to 24 μm.

### (2) Production of LTO Green Sheet (Negative Electrode Green Sheet)

100 Parts by weight of LTO powder (volume-based D₅₀ particle diameter: 0.06 μm, manufactured by Sigma-Aldrich Japan K.K.), 100 parts by weight of a dispersion medium (toluene:isopropanol=1:1), 20 parts by weight of a binder (polyvinyl butyral: product number: BM-2, manufactured by Sekisui Chemical Co., Ltd.), 4 parts by weight of a plasticizer (di(2-ethylhexyl) phthalate (DOP), manufactured by Kurogane Kasei Co., Ltd.), and 2 parts by weight of a dispersant (product name: RHEODOL SP-O30, manufactured by Kao Corporation) were mixed. The resultant mixture of negative electrode raw materials was stirred under reduced pressure to be defoamed, and its viscosity was adjusted to 4,000 cP. Thus, an LTO slurry was prepared. The prepared slurry was molded into a sheet shape on the PET film. Thus, an LTO green sheet was formed. The thickness of a negative electrode layer after its firing was adjusted to 10 μm.

### (2′) Formation of Collector Layer

A Au paste (manufactured by Tanaka Kikinzoku Kogyo K.K., product name: GB-2706) was printed on one surface of the LTO green sheet produced in the section (2) with a printer. The thickness of the printed layer after its firing was set to 0.2 μm.

### (3) Production of Separator Green Sheet

Magnesium carbonate powder (manufactured by Konoshima Chemical Co., Ltd.) was thermally treated at 900° C. for 5 hours to provide MgO powder. The resultant MgO powder and a glass frit (manufactured by Nippon Frit Co., Ltd., CK0199) were mixed at a weight ratio of 7:3. 100 Parts by weight of the resultant mixture powder (volume-based D₅₀ particle diameter: 0.4 μm), 100 parts by weight of a dispersion medium (toluene:isopropanol=1:1), 30 parts by weight of a binder (polyvinyl butyral: product number: BM-2, manufactured by Sekisui Chemical Co., Ltd.), 6 parts by weight of a plasticizer (di(2-ethylhexyl) phthalate (DOP), manufactured by Kurogane Kasei Co., Ltd.), and 2 parts by weight of a dispersant (product name: RHEODOL SP-O30, manufactured by Kao Corporation) were mixed. The resultant raw material mixture was stirred under reduced pressure to be defoamed, and its viscosity was adjusted to 4,000 cP. Thus, a slurry was prepared. The prepared slurry was molded into a sheet shape on the PET film. Thus, a separator green sheet was formed. The thickness of a separator layer positioned between the positive electrode layer and the negative electrode layer was adjusted to become 25 μm after firing. The thickness of the separator (insulating layer) positioned adjacent to the positive electrode layer was adjusted to become 24 μm after firing. The thickness of the separator (insulating layer) positioned adjacent to the negative electrode layer was adjusted to become 20 μm after firing.

### 2. Cutting of Sheets

The green sheets obtained in the section 1. were cut in order to laminate the green sheets.

### 3. Lamination, Pressure Bonding, and Cutting of Laminate

Various green sheets were laminated as illustrated in [FIG. 4]. When two LTO green sheets were superimposed, the lamination was performed so that their collector layers were brought into contact with each other. The sheets were repeatedly stacked in the order illustrated in FIG. 4 so that the number of cells formed in the laminate became nineteen (FIG. 4 shows only a part of the repetition). The resultant laminate was pressed by cold isostatic pressing (CIP) at 100 kgf/cm² so that the green sheets were pressure-bonded to each other. Thus, an unfired green sheet laminate was obtained. In the pressing, a pressure was applied in the thickness direction of the green sheets. Subsequently, the unfired green sheet laminate was cut. In Examples 1 and 2, Examples 101 and 102, Comparative Examples 1 to 3, and Comparative Examples 101 to 104, as illustrated in [FIG. 5], the unfired green sheet laminate was cut through use of a Thomson blade so that the laminate had 5 mm in each of the width direction and the depth direction of the laminate. Thus, a rectangular-shape laminate was obtained. In Examples 3 and 4, Examples 103 and 104, Comparative Examples 5 to 7, and Comparative Examples 105 to 108, as illustrated in [FIG. 6], the unfired green sheet laminate was cut through use of a hand puncher so that the laminate became a cylindrical body having a diameter of 16 mm. Further, the side surfaces were cut so that a round-shape laminate having flat side surfaces was obtained. In Example 105, as illustrated in part (7) of [FIG. 10], the unfired green sheet laminate was cut through use of a hand puncher so that the laminate became a cylindrical body having a diameter of 16 mm. Further, a via passing through the positive electrode layers and a via passing through the negative electrode layers were formed.

### 4. Preparation of Side Edge Layer Paste

### (1) Paste for Positive Electrode Side Edge Layer

First, Co₃O₄ powder (manufactured by Seido Chemical Industry Co., Ltd.) and Li₂CO₃ powder (manufactured by the Honjo Chemical Corporation) weighed so that the molar ratio “Li/Co” became 1.01 were mixed, and then, the mixture was held at 780° C. for 5 hours. The resultant powder was pulverized in a pot mill so that a volume-based D₅₀ particle diameter became 0.4 μm. Thus, powder formed of LCO plate-like particles was obtained. 100 Parts by weight of the resultant LCO powder, 20 parts by weight of a dispersion medium (2-ethylhexanol), 8 parts by weight of a binder (polyvinyl butyral: product number: BM-2, manufactured by Sekisui Chemical Co., Ltd.), 2 parts by weight of a plasticizer (di(2-ethylhexyl) phthalate (DOP), manufactured by Kurogane Kasei Co., Ltd.), and 4.5 parts by weight of a dispersant (product name: RHEODOL SP-O30, manufactured by Kao Corporation) were mixed. The resultant mixture was stirred under reduced pressure to be defoamed. Thus, an LCO paste was prepared. Further, a TR-1535R paste manufactured by Tanaka Kikinzoku Kogyo K.K. was prepared as a Au paste. Next, the LCO paste and the Au paste were mixed at a volume ratio shown in [Table 1] and [Table 2] (Examples 1 to 4, Example 105, and Comparative Examples 1 to 7). Further, a TR-1535R paste manufactured by Tanaka Kikinzoku Kogyo K.K. was prepared as a Pt paste. Next, the LCO paste and the Pt paste were mixed at a volume ratio shown in [Table 1] and [Table 2] (Example 101 and Comparative Examples 101 and 102). Further, Ir powder (IRE02PB, manufactured by Kojundo Chemical Lab. Co., Ltd.) was prepared as Ir, and an Ir paste was produced in a procedure similar to that for producing the LCO paste. Next, the LCO paste and the Ir paste were mixed at a volume ratio shown in [Table 1] and [Table 2] (Example 102 and Comparative Examples 103 and 104). The pastes were mixed by putting the two pastes in a container and mixing the two pastes with a glass bar five hundred times.

TABLE 1

| | | | | Negative electrode side surface collector | |
|---|---|---|---|---|---|
| | | Positive electrode side surface collector | | Negative electrode | |
| | Electrode | Positive electrode side edge | Positive electrode collector | side edge layer | Negative electrode collector |
| | shape | layer (integral firing) | (attached after firing) | (integral firing) | (attached after firing) |
| Example 1 | Rectangular | 100 vol % of LCO + 0 vol % of Au | (Carbon paste) + (Al foil) | 100 vol % of Au | (Carbon paste) + (Al foil) |
| Example 2 | shape | 70 vol % of LCO + 30 vol % of Au | (Carbon paste) + (Al foil) | 100 vol % of Au | (Carbon paste) + (Al foil) |
| Example 101 | | 70 vol % of LCO + 30 vol % of Pt | (Carbon paste) + (Al foil) | 100 vol % of Au | (Carbon paste) + (Al foil) |
| Example 102 | | 70 vol % of LCO + 30 vol % of Ir | (Carbon paste) + (Al foil) | 100 vol % of Au | (Carbon paste) + (Al foil) |
| Comparative | | 60 vol % of LCO + 40 vol % of Au | (Carbon paste) + (Al foil) | 100 vol % of Au | (Carbon paste) + (Al foil) |
| Example 1 | | | | | |
| Comparative | | 0 vol % of LCO + 100 vol % of Au | (Carbon paste) + (Al foil) | 100 vol % of Au | (Carbon paste) + (Al foil) |
| Example 2 | | | | | |
| Comparative | | — | (Carbon paste) + (Al foil) | 100 vol % of Au | (Carbon paste) + (Al foil) |
| Example 3 | | (Carbon paste application after firing) | | | |
| Comparative | | 60 vol % of LCO + 40 vol % of Pt | (Carbon paste) + (Al foil) | 100 vol % of Au | (Carbon paste) + (Al foil) |
| Example 101 | | | | | |
| Comparative | | 0 vol % of LCO + 100 vol % of Pt | (Carbon paste) + (Al foil) | 100 vol % of Au | (Carbon paste) + (Al foil) |
| Example 102 | | | | | |
| Comparative | | 60 vol % of LCO + 40 vol % of Ir | (Carbon paste) + (Al foil) | 100 vol % of Au | (Carbon paste) + (Al foil) |
| Example 103 | | | | | |
| Comparative | | 0 vol % of LCO + 100 vol % of Ir | (Carbon paste) + (Al foil) | 100 vol % of Au | (Carbon paste) + (Al foil) |
| Example 104 | | | | | |

TABLE 2

| | | | | Negative electrode side surface collector | |
|---|---|---|---|---|---|
| | | Positive electrode side surface collector | | Negative electrode | |
| | Electrode | Positive electrode side edge | Positive electrode collector | side edge layer | Negative electrode collector |
| | shape | layer (integral firing) | (attached after firing) | (integral firing) | (attached after firing) |
| Example 3 | Round | 100 vol % of LCO + 0 vol % of Au | (Carbon paste) + (Al foil) | 100 vol % of Au | (Carbon paste) + (Al foil) |
| Example 4 | shape | 70 vol % of LCO + 30 vol % of Au | (Carbon paste) + (Al foil) | 100 vol % of Au | (Carbon paste) + (Al foil) |
| Example 103 | (with cut | 70 vol % of LCO + 30 vol % of Pt | (Carbon paste) + (Al foil) | 100 vol % of Au | (Carbon paste) + (Al foil) |
| Example 104 | side | 70 vol % of LCO + 30 vol % of Ir | (Carbon paste) + (Al foil) | 100 vol % of Au | (Carbon paste) + (Al foil) |
| Comparative | surfaces) | 60 vol % of LCO + 40 vol % of Au | (Carbon paste) + (Al foil) | 100 vol % of Au | (Carbon paste) + (Al foil) |
| Example 5 | | | | | |
| Comparative | | 0 vol % of LCO + 100 vol % of Au | (Carbon paste) + (Al foil) | 100 vol % of Au | (Carbon paste) + (Al foil) |
| Example 6 | | | | | |
| Comparative | | — | (Carbon paste) + (Al foil) | 100 vol % of Au | (Carbon paste) + (Al foil) |
| Example 7 | | (Carbon paste application after firing) | | | |
| Comparative | | 60 vol % of LCO + 40 vol % of Pt | (Carbon paste) + (Al foil) | 100 vol % of Au | (Carbon paste) + (Al foil) |
| Example 105 | | | | | |
| Comparative | | 0 vol % of LCO + 100 vol % of Pt | (Carbon paste) + (Al foil) | 100 vol % of Au | (Carbon paste) + (Al foil) |
| Example 106 | | | | | |
| Comparative | | 60 vol % of LCO + 40 vol % of Ir | (Carbon paste) + (Al foil) | 100 vol % of Au | (Carbon paste) + (Al foil) |
| Example 107 | | | | | |
| Comparative | | 0 vol % of LCO + 100 vol % of Ir | (Carbon paste) + (Al foil) | 100 vol % of Au | (Carbon paste) + (Al foil) |
| Example 108 | | | | | |
| Example 105 | Round | (Positive electrode conducting portion) | (Carbon paste) + (Al foil) | (Negative electrode | (Carbon paste) + (Al foil) |
| | shape | 100 vol % of LCO + 0 vol % of Au | | conducting portion) | |
| | | | | 100 vol % of Au | |

### (2) Paste for Negative Electrode Side Edge Layer

A TR-1535R paste manufactured by Tanaka Kikinzoku Kogyo K.K. was prepared as a Au paste.

### 5. Transfer of Side Edge Layer Paste

In Examples 1 to 4, Examples 101 to 104, Comparative Examples 1 to 7, and Comparative Examples 101 to 108, the paste for the positive electrode side edge layer produced in the section 4(1) described above was applied to a silicon resin film so that its thickness after firing became 50 μm. Then, the side surface of the green sheet laminate on the side at which the positive electrodes were exposed was pressed against the paste from above so that the paste was transferred.

Further, the paste for the negative electrode side edge layer produced in the section 4(2) described above was applied to a silicon resin film so that its thickness after firing became 20 μm. Then, the side surface of the green sheet laminate on the side at which the negative electrodes were exposed was pressed against the paste from above so that the paste was transferred.

In Example 105, out of the vias formed in the laminate, the via passing through the positive electrode layers was filled with the paste for the positive electrode side edge layer produced in the section 4(1) described above. Further, the via passing through the negative electrode layers was filled with the paste for the negative electrode side edge layer produced in the section 4(2) described above.

### 6. Degreasing and Firing

The green sheet laminate produced in the section 5. was degreased for five hours by increasing the temperature from room temperature to 600° C., and was fired by increasing the temperature to 800° C. and holding the laminate for 10 minutes. After that, the laminate was cooled. Thus, a laminated integrated sintered body was obtained.

### Evaluation 1: Yield Evaluation

The presence or absence of peeling in a boundary part between the laminate and the side edge layer in the laminated integrated sintered body was visually checked. A percentage of the number of samples without peeling with respect to the number of produced laminated integrated sintered body samples was calculated as a yield percentage (%) in accordance with the following equation.

$$Yield percentage ( \% ) =$$

$$100 \times ( number of samples without peeling after firing ) /$$

$$( number of produced samples )$$

### 7. Preparation of Conductive Carbon Paste

A binder (CMC: MAC350HC, manufactured by Nippon Paper Industries Co., Ltd.) was weighed so that its concentration became 1.2 wt % with respect to pure water, followed by its dissolution in the water through mixing with a stirrer. Thus, a 1.2 wt % CMC solution was obtained. A carbon dispersion liquid (product number: BPW-229, manufactured by Nippon Graphite Industries, Co., Ltd.) and a dispersing material solution (product number: LB-300, manufactured by Showa Denko K.K.) were prepared. Subsequently, the carbon dispersion liquid, the dispersing material solution, and the 1.2 wt % CMC solution were weighed so that their ratio became 0.22:0.29:1, followed by the mixing of the materials with a rotary and revolutionary mixer. Thus, a conductive carbon paste was prepared.

### 8. Joining of Positive Electrode Side Edge Layer of Laminated Integrated Sintered Body and Aluminum Foil Via Conductive Carbon Paste

The conductive carbon paste obtained in the section 7. was printed on aluminum foil serving as a positive electrode collector by screen printing.

In Examples 1 to 4, Examples 101 to 104, Comparative Examples 1 to 7, and Comparative Examples 101 to 108, the laminated integrated sintered body obtained in the section 3. was mounted so that its positive electrode side edge layer was bonded within the undried printed pattern (region having applied thereto the conductive carbon paste). The sintered body and the aluminum foil were lightly pressed down with a finger, and then, the resultant was dried in a vacuum at 50° C. for 60 minutes. Thus, the positive electrode side edge layer of the laminated integrated sintered body and the positive electrode collector were bonded to each other via the conductive carbon adhesion layer. The thickness of the conductive carbon adhesive layer was set to 30 μm.

In Example 105, the positive electrode collector was arranged on the end surface at which the positive electrode conducting portion was exposed out of the end surfaces of the cylindrical body in the laminating direction. The positive electrode collector was joined via a conductive carbon adhesion layer in the same manner as in other examples under the same conditions as in other examples.

### 9. Joining of Negative Electrode Side Edge Layer of Laminated Integrated Sintered Body and Aluminum Foil Via Conductive Carbon Paste

In Examples 1 to 4, Examples 101 to 104, Comparative Examples 1 to 7, and Comparative Examples 101 to 108, aluminum foil serving as a negative electrode collector was bonded to the negative electrode side edge layer of the laminated integrated sintered body via a conductive carbon adhesion layer in the same manner as in the section 8.

In Example 105, the negative electrode collector was arranged on the end surface at which the negative electrode conducting portion was exposed out of the end surfaces of the cylindrical body in the laminating direction. The negative electrode collector was joined via a conductive carbon adhesion layer in the same manner as in other examples under the same conditions as in other examples.

### 10. Production of Lithium Secondary Battery

The positive electrode collector, the laminated integrated sintered body, and the negative electrode collector were placed between a positive electrode can and a negative electrode can, which were intended to form a battery case, so that the collectors and the sintered body were laminated in the stated order from the positive electrode can to the negative electrode can, followed by the loading of an electrolytic solution. After that, the positive electrode can and the negative electrode can were sealed by caulking through a gasket. Thus, a lithium secondary battery of a coin cell form having a diameter of 20 mm and a thickness of 1.6 mm was produced. A liquid obtained as follows was used as the electrolytic solution:propylene carbonate (PC) and γ-butyrolactone (GBL) were mixed at a volume ratio of 1:3; and LiPF₆ was dissolved in the resultant organic solvent so that its concentration became 1.5 mol/L.

Evaluation 2. Evaluation of Battery Performance (Evaluation of 0.2C Discharge Capacity)

The battery capacity of the resultant battery including the laminated integrated sintered body was determined in an environment at 25° C. The battery was charged at a constant current of 0.2C, and the charge was performed until its voltage reached 2.7 V. The battery was discharged at a constant current of 0.2C, and the discharge was performed until its voltage reached 1.5 V. The second cycle of charge and discharge was performed under the same conditions as those of the first cycle, and a discharge capacity in the second cycle was defined as a 0.2C discharge capacity.

Evaluation 3. Evaluation of Battery Performance (Evaluation of Resistance Immediately after Discharge Start)

A resistance after elapse of one second from the start of the discharge in the second cycle was measured to achieve a resistance immediately after discharge start.

### [Evaluation Results]

Regarding the lithium secondary batteries of Examples 1 to 4, Examples 101 to 105, Comparative Examples 1 to 7, and Comparative Examples 101 to 108, the results of the evaluation of the 0.2C discharge capacity and the resistance value and the yield evaluation (yield percentage) in production of the sintered body are summarized in [Table 3] and [Table 4].

TABLE 3

| | | Positive | | 1 Hz | | |
|---|---|---|---|---|---|---|
| | | electrode side | | resistance | | |
| | | edge layer | 0.2 C | immediately | | Comprehensive |
| | Electrode | Volume ratio | discharge | after | Yield | evaluation |
| | shape | of LCO:metal | capacity | discharge start | percentage | (pass/fail) |
| Example 1 | Rectangular | 100:0 | 6.0 mAh | 2.2 Ω | 100% | ∘ |
| Example 2 | shape | 70:30 | 6.0 mAh | 2.1 Ω | 90% | ∘ |
| Example 101 | | 70:30 | 6.0 mAh | 2.0 Ω | 90% | ∘ |
| Example 102 | | 70:30 | 6.0 mAh | 2.1 Ω | 92% | ∘ |
| Comparative | | 60:40 | 6.0 mAh | 2.1 Ω | 10% | x |
| Example 1 | | | | | | |
| Comparative | | 0:100 | (Unmeasurable) | (Unmeasurable) | 0% | x |
| Example 2 | | | | | | |
| Comparative | | — | 6.0 mAh | 3.0 Ω | 100% | x |
| Example 3 | | | | | | |
| Comparative | | 60:40 | 6.0 mAh | 2.0 Ω | 10% | x |
| Example 101 | | | | | | |
| Comparative | | 0:100 | (Unmeasurable) | (Unmeasurable) | 0% | x |
| Example 102 | | | | | | |
| Comparative | | 60:40 | 6.0 mAh | 2.1 Ω | 15% | x |
| Example 103 | | | | | | |
| Comparative | | 0:100 | (Unmeasurable) | (Unmeasurable) | 0% | x |
| Example 104 | | | | | | |

TABLE 4

| | | Positive | | 1 Hz | | |
|---|---|---|---|---|---|---|
| | | electrode side | | resistance | | |
| | | edge layer | 0.2 C | immediately | | Comprehensive |
| | Electrode | Volume ratio | discharge | after discharge | Yield | evaluation |
| | shape | of LCO:metal | capacity | start | percentage | (pass/fail) |
| Example 3 | Round | 100:0 | 7.2 mAh | 1.9 Ω | 100% | ∘ |
| Example 4 | shape | 70:30 | 7.2 mAh | 1.9 Ω | 100% | ∘ |
| Example 103 | (with cut | 70:30 | 6.0 mAh | 1.8 Ω | 98% | ∘ |
| Example 104 | side | 70:30 | 6.0 mAh | 1.8 Ω | 100% | ∘ |
| Comparative | surfaces) | 60:40 | 7.2 mAh | 1.8 Ω | 20% | x |
| Example 5 | | | | | | |
| Comparative | | 0:100 | (Unmeasurable) | (Unmeasurable) | 0% | x |
| Example 6 | | | | | | |
| Comparative | | — | 7.2 mAh | 2.9 Ω | 100% | x |
| Example 7 | | | | | | |
| Comparative | | 60:40 | 6.0 mAh | 1.8 Ω | 20% | x |
| Example 105 | | | | | | |
| Comparative | | 0:100 | (Unmeasurable) | (Unmeasurable) | 0% | x |
| Example 106 | | | | | | |
| Comparative | | 60:40 | 6.0 mAh | 1.8 Ω | 25% | x |
| Example 107 | | | | | | |
| Comparative | | 0:100 | (Unmeasurable) | (Unmeasurable) | 0% | x |
| Example 108 | | | | | | |
| Example 105 | Round | 100:0 | 7.0 mAh | 1.7 Ω | 100% | ∘ |
| | shape | | | | | |

As shown in [Table 3] and [Table 4], the lithium secondary battery of each of Examples 1 to 4 and Examples 101 to 105 in which the positive electrode connection portion (positive electrode side edge layer, positive electrode conducting portion) contained 70% or more of LCO being the positive electrode active material had a resistance value lower than that of each of Comparative Example 3 and Comparative Example 7 having no positive electrode connection portion. Further, in each of Comparative Example 1 and Comparative Example 5 in which, although the positive electrode side edge layer was included, the positive electrode active material was lower than 70%, peeling occurred in the sintered body, and hence the yield percentage was low. In contrast, the lithium secondary battery of each of Examples 1 to 4 and Examples 101 to 105 in which the positive electrode connection portion contained 70% or more of LCO being the positive electrode active material had a yield percentage of 90% or more, and the yield percentage was remarkably high. Moreover, in each of Comparative Example 2 and Comparative Example 6 in which the positive electrode side edge layer was formed of only Au, peeling occurred at the interface between the laminate and the side edge layer, and hence a sintered body for forming a secondary battery was not able to be obtained.

As shown in the evaluation results of [Table 3] and [Table 4], it was confirmed that, when the positive electrode connection portion containing the positive electrode active material at a percentage of 70% or more was arranged on the positive electrode side of the laminate including the positive electrode layers, the negative electrode layers, and the separator, a lithium secondary battery having a low internal resistance was able to be stably produced with a good yield.

It is to be understood that the embodiments disclosed herein are merely examples in all aspects and in no way intended to limit the present disclosure. The scope of the present disclosure is defined by the appended claims and not by the above description, and it is intended that the present disclosure encompasses all modifications made within the scope and spirit equivalent to those of the appended claims.

### REFERENCE SIGNS LIST

1, 51 laminate, 5 electrode, 10 lithium secondary battery, 12 positive electrode layer, 16 negative electrode layer, 14 positive electrode collector, 18 negative electrode collector, 20 separator, 22 electrolytic solution, 24 exterior body, 24a positive electrode can, 24b negative electrode can, 24c gasket, 41 positive electrode side edge layer, 42 negative electrode side edge layer, 9, 50 sintered body, 541 positive electrode conducting portion, 542 negative electrode conducting portion, 551, 552 via, 101, 501 green sheet laminate, 112 positive electrode green sheet, 116 negative electrode green sheet, 120 separator green sheet, 141 positive electrode side edge material paste, 142 negative electrode side edge material paste.

1. A lithium secondary battery, comprising a sintered body, the sintered body including a laminate portion which includes a plurality of positive electrode layers, a plurality of negative electrode layers, and a separator, and in which the plurality of positive electrode layers and the plurality of negative electrode layers are alternately laminated through the separator,
wherein the sintered body includes a positive electrode connection portion connected to at least two or more of the plurality of positive electrode layers included in the laminate portion, the positive electrode connection portion containing 70 vol % or more and 100 vol % or less of a positive electrode active material for forming the plurality of positive electrode layers.

2. The lithium secondary battery according to claim 1, wherein the positive electrode connection portion is a positive electrode side edge layer formed on, out of side surfaces of the sintered body, a first side surface that is a surface at which the plurality of positive electrode layers and the separator are exposed, the positive electrode side edge layer being in contact with end portions of the plurality of positive electrode layers included in the laminate portion.

3. The lithium secondary battery according to claim 1, wherein the positive electrode connection portion is a columnar portion extending so as to pass through the plurality of positive electrode layers and the separator in a laminating direction.

4. The lithium secondary battery according to claim 1, wherein the positive electrode connection portion is sintered integrally with the laminate portion.

5. The lithium secondary battery according to claim 1, wherein the positive electrode connection portion further contains a metal of at least one kind selected from the group consisting of Au (gold), Pt (platinum), and Ir (iridium).

6. The lithium secondary battery according to claim 2, further comprising a current collector provided on an outer side of the positive electrode side edge layer.

7. The lithium secondary battery according to claim 2, further comprising, on a second side surface that is a side surface opposed to the first side surface, a negative electrode side edge layer formed of a metal of at least one kind selected from the group consisting of Au (gold), Pt (platinum), Ir (iridium), Pd (palladium), Ag (silver), Rh (rhodium), and Cu (copper), the negative electrode side edge layer being in contact with end portions of the plurality of negative electrode layers included in the laminate portion.

8. The lithium secondary battery according to claim 1,
wherein each of the plurality of positive electrode layers includes a lithium composite oxide sintered body, and
wherein each of the plurality of negative electrode layers includes a titanium-containing sintered body.

9. The lithium secondary battery according to claim 2, wherein the positive electrode connection portion is sintered integrally with the laminate portion.

10. The lithium secondary battery according to claim 2, wherein the positive electrode connection portion further contains a metal of at least one kind selected from the group consisting of Au (gold), Pt (platinum), and Ir (iridium).

11. The lithium secondary battery according to claim 2,
wherein each of the plurality of positive electrode layers includes a lithium composite oxide sintered body, and
wherein each of the plurality of negative electrode layers includes a titanium-containing sintered body.

12. The lithium secondary battery according to claim 3, wherein the positive electrode connection portion is sintered integrally with the laminate portion.

13. The lithium secondary battery according to claim 3, wherein the positive electrode connection portion further contains a metal of at least one kind selected from the group consisting of Au (gold), Pt (platinum), and Ir (iridium).

14. The lithium secondary battery according to claim 3,
wherein each of the plurality of positive electrode layers includes a lithium composite oxide sintered body, and
wherein each of the plurality of negative electrode layers includes a titanium-containing sintered body.
